(19) United States
(12) Patent Application Publication
(10) Pub. No.: US 2026/0179592 A1
(43) Pub. Date: Jun. 25, 2026

(54) ELECTRONIC MUSICAL INSTRUMENT, SOUND PRODUCTION CONTROL METHOD, AND STORAGE MEDIUM

(71) Applicant: CASIO COMPUTER CO., LTD., Tokyo (JP)

(72) Inventor: Rie MAEDA, Tokyo (JP)

(73) Assignee: CASIO COMPUTER CO., LTD., Tokyo (JP)

(21) Appl. No.: 19/429,233

(22) Filed: Dec. 22, 2025

(30) Foreign Application Priority Data
Dec. 23, 2024 (JP) 2024-226109

(51) Int. Cl. G10H 1/00; G10H 1/053

(52) U.S. Cl. CPC G10H 1/0008; G10H 1/053; G10H 2210/111; G10H 2210/145; G10H 2210/331; G10H 2220/221

(57) ABSTRACT

An electronic musical instrument includes operation elements, sound producer, and processor. The processor starts progressing a musical piece, based on musical-piece data. In response to a current operation of an operation element among the operation elements being performed by a user while the musical piece is in progress, the processor determines whether the current operation is performed after a lapse of a predetermined time from an operation immediately before the current operation. In response to determining that the current operation is performed before the lapse of the predetermined time, the processor causes the sound producer to sound a chord-constituting note at a timing of the current operation in the musical piece. In response to determining that the current operation is performed after the lapse of the predetermined time, the processor causes the sound producer to sound a melody note at the timing of the current operation in the musical piece.

### CROSS-REFERENCE TO RELATED APPLICATIONS

The present application claims priority under Paris Convention to Japanese Patent Application No. 2024-226109, filed on Dec. 23, 2024, the disclosure of which, including description, claims, abstract and drawings, is incorporated herein by reference in its entirety.

### BACKGROUND

### Technical Field

The present disclosure relates to an electronic musical instrument, a sound production control method, and a storage medium.

### Description of Related Art

An electronic musical instrument according to a known technology obtains chord information of a musical piece, replaces the pitch of a note played by a player (user) with one of chord-constituting notes, based on the chord information of the musical piece, and sounds the chord-constituting note.

For example, according to Japanese patent application publication No. 2000-172253, an electronic musical instrument receives chord information on the left half of the keyboard, replaces the pitch input on the right half of the keyboard (the pitch played by the player) with a chord-constituting note of the input chord information, and sounds the chord-constituting note.

### SUMMARY

An electronic musical instrument according to an aspect of the present disclosure includes: multiple operation elements; a sound producer; and a processor that: starts progressing a musical piece, based on musical piece data; in response to a current operation of an operation element among the operation elements being performed by a user while the musical piece is in progress, determines whether the current operation is performed after a lapse of a predetermined time from an operation immediately before the current operation; in response to determining that the current operation is performed before the lapse of the predetermined time, causes the sound producer to sound a chord-constituting note among chord-constituting notes at a timing of the current operation in the musical piece; and in response to determining that the current operation is performed after the lapse of the predetermined time, causes the sound producer to sound a current melody note at the timing of the current operation in the musical piece.

### BRIEF DESCRIPTION OF DRAWINGS

FIG. 1 is a block diagram showing a functional configuration of an electronic musical instrument according to an embodiment of the present disclosure.

FIG. 2 schematically shows main switches included in an operation receiver.

FIG. 3 is a diagram for explaining an overview of operations of the electronic musical instrument in FIG. 1.

FIG. 4 is a flowchart of main processing to be executed by a CPU in FIG. 1.

FIG. 5 is a flowchart of a musical piece playback process to be executed in step S104 of FIG. 4.

FIG. 6 is a flowchart of a performance operation process to be executed in step S105 of FIG. 4.

FIG. 7 is a flowchart of the performance operation process to be executed in step S105 of FIG. 4.

FIG. 8 is a flowchart of the performance operation process to be executed in step S105 of FIG. 4.

FIG. 9 is a flowchart of a root note determination process to be executed in step S314 of FIG. 7.

FIG. 10 is a diagram for explaining how to derive a candidate chord-constituting note for sound production.

FIG. 11 shows a case where a melody is sounded and a case where a chord is sounded in response to the user performance while a musical piece is played (in progress) in the electronic musical instrument of FIG. 1.

FIG. 12 shows key press data (one or two notes) and sound production data corresponding to the key press data while a musical piece is in progress in the electronic musical instrument of FIG. 1.

FIG. 13 shows key press data (three notes) and sound production data corresponding to the key press data while a musical piece is in progress in the electronic musical instrument of FIG. 1.

### DETAILED DESCRIPTION

According to JP 2000-172253A, the melody and chords of a musical piece cannot be sounded well without dividing the keyboard region.

According to an aspect of the present disclosure, the electronic musical instrument can produce good sounds no matter how the user plays a musical piece including a melody and chords.

If the embodiment of the present disclosure described below is not adopted, the electronic musical instrument sounds a melody note in response to a key press and keeps sounding the melody note at the same pitch until the key corresponding to the melody note is released. Accordingly, the next melody note is not sounded, and the melody does not progress while the musical piece is in progress.

According to the present disclosure, the electronic musical instrument appropriately sounds a new melody note in response to a new key press according to the musical piece in progress, even if a key that sounded the previous melody note is not released. Therefore, the melody progresses appropriately.

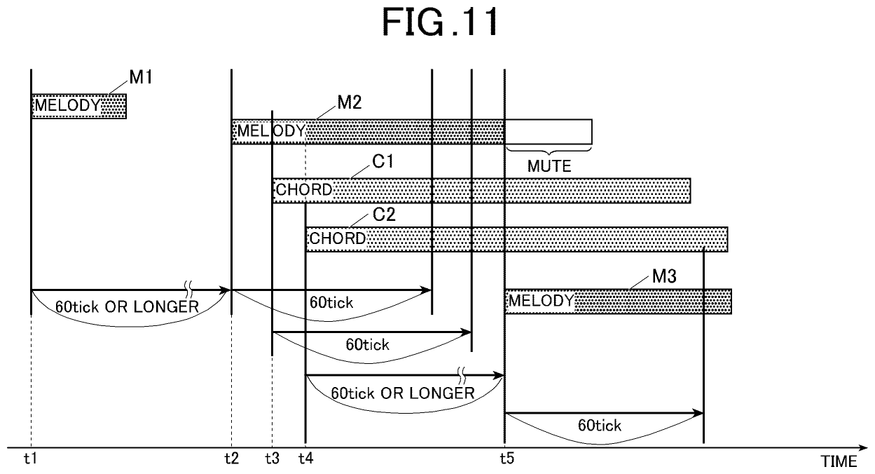

Herein, assuming that the current melody note is M3 in FIG. 11, the previous melody note is M2. The current melody note may have the same pitch as the previous melody note. For example, consider a case where the interval between the previous designation (key-press) timing and the current designation timing is longer than 60 ticks and no pitch is designated during the interval. If (i) the currently designated pitch by the user is different from the previously designated pitch but (ii) the melody data stored in the melody memory area of the RAM 103 at the current designation timing is the same as the melody data stored in the melody memory area of the RAM 103 at the previous designation timing, the same pitch is sounded for the current melody note and the previous melody note.

In an embodiment of the present disclosure, whether to sound a melody note is determined, based on a time lag between the current key press and the last key press immediately before the current key press. In a different embodiment, whether to sound a melody note may be determined, based on a time lag between the current key press and the key press that sounded a melody note last time.

In the embodiment of the present disclosure, a predetermined time (lag) is set to 60 ticks. Instead of ticks, units of actual time (e.g., one second) may be used. The predetermined time may be set to 40 ticks, shorter than 60 ticks. Since a melody plays a key role in a musical piece, it is preferable to appropriately sound good melody notes in response to user performance operations. In order to appropriately sound good melody notes, it is not preferable to set the predetermined time to a longer period (e.g., 100 or 200 ticks). If the predetermined time is not set, there may be a case where only melody notes are sounded and chord-constituting notes are not sounded. In such a case, sounding both the melody notes and the chord-constituting notes well requires an additional algorithm, which increases the CPU load.

Hereinafter, an embodiment of the present disclosure is described with reference to the figures. The embodiment described below is provided with various limitations technically preferable for implementing the present disclosure. The technical scope of the present disclosure is not limited to the following embodiment or illustrated examples.

First, a configuration of an electronic musical instrument 1 as an embodiment of the present disclosure is described. In response to a key press by the user, the electronic musical instrument 1 can change the pitch of the pressed key to a different pitch and outputs the different pitch. The different pitch is calculated, based on a melody or chord information specified in a musical piece.

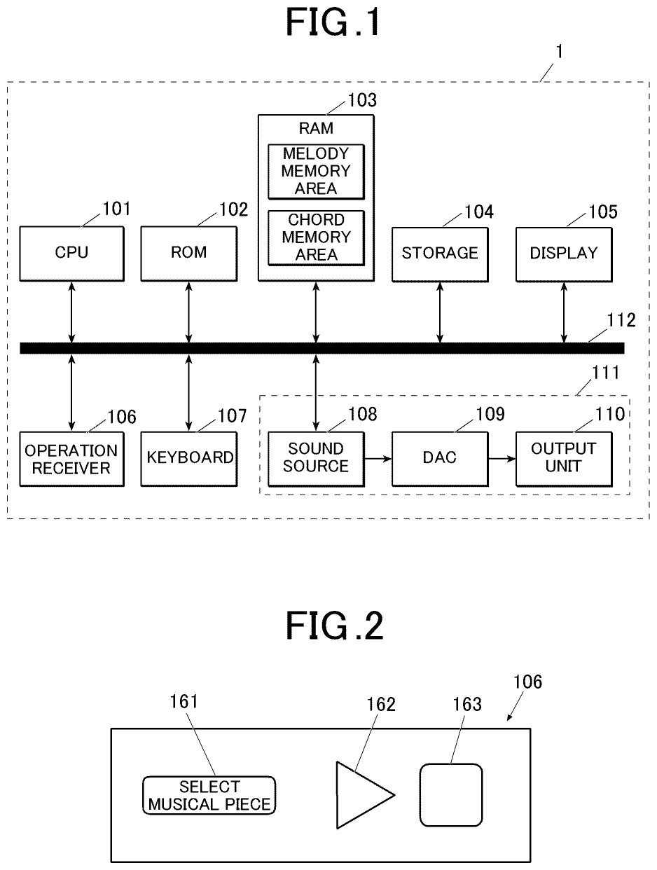

As shown in FIG. 1, the electronic musical instrument 1 includes a central processing unit (CPU) 101, a read only memory (ROM) 102, a random access memory (RAM) 103, a storage 104, a display 105, an operation receiver 106, a keyboard 107, a sound source 108, a digital analog converter (DAC) 109, and an output unit 110. These components are connected by a bus 112.

The CPU 101 (processor) is a computer that controls each component of the electronic musical instrument 1 and functions as a controller. The CPU 101 reads a specified program from programs stored in the ROM 102 or the storage 104, loads the program in the RAM 103, and executes various processes in accordance with the loaded program. The CPU 101 may consist of multiple CPUs. The multiple CPUs may execute multiple processes of the CPU 101.

The ROM 102 stores programs and various kinds of data. The RAM 103 provides working memory space to the CPU 101 and stores temporary data. The RAM 103 includes a melody memory area that retains melody data of a melody at the current timing (at the current processing position) according to the progress of a musical piece. The RAM 103 further includes: a chord memory area that retains chord information of a chord at the current timing (at the current processing position) according to the progress of the musical piece; and a chord-constituting note memory area that retains chord-constituting notes constituting the chord. The RAM 103 further includes a being-sounded melody area that retains the note number of a pressed key position in association with the note number of a melody note being sounded in response to the key press. The RAM 103 further includes a being-sounded chord area that retains the note number of a pressed key position in association with the note number of a chord-constituting note being sounded in response to the key press. The RAM 103 further includes a musical piece memory area for loading musical piece data of the selected musical piece.

The storage 104 includes a nonvolatile semiconductor memory, such as a flash memory, and/or a hard disk drive (HDD), for example. The storage 104 stores programs and various kinds of data. The storage 104 is not limited to a built-in storage in the electronic musical instrument 1. The storage 104 may include an external storage medium detachable from the electronic musical instrument 1, such as an external HDD or a USB memory.

In this embodiment, the storage 104 stores musical piece data on musical pieces (e.g., standard MIDI files (SMF)). The musical piece data includes events, such as note-on events, note-off events, and control change events for each of one or more parts (e.g., piano part, electric guitar part, trumpet part, bass part, and drum part) from the beginning to the end of a musical piece. A note-on event is an event that indicates sound production and includes information on at least a pitch and a velocity value (strength). A note-off event is an event that indicates mute and includes information on at least a pitch. Control change events include events related to control of expressions added to musical notes, such as sound volume and quality, and events related to control of other aspects, such as master volume changes, panning, and so forth. In this embodiment, the piano part (user performance part) includes the melody part (the melody part may also be called a first part). The melody data includes events of the piano part. For another example, the user may determine the melody part among the parts by manipulating the operation receiver 106.

The musical piece data further includes chord information. For example, when the musical piece data is an SMF, the chord information is stored in the zeroth (0th) track called the system track, using a meta-event marker. The data format of an SMF meta event is FFH, event number, data length, and data. The event number of the marker is 6, the data length is the number of data bytes, and the data is a string. To indicate a chord name with the marker, the chord name string is set to the string part. For example, when the chord name is Cm7, the string length is three, and the marker event is FFH, 06H, 03H, ‘C’, ‘m’, ‘7’.

The storage 104 further stores a non-illustrated chord-constituting note table. The chord-constituting note table stores chord information (chord name) in association with the chord-constituting notes constituting the chord indicated by the chord information. The chord-constituting notes are stored in order from lower pitches starting with the root note, which is the lowest chord-constituting note.

The display 105 includes a liquid crystal display (LCD) or an electro luminescence (EL) display, for example. The display 105 displays various kinds of contents in accordance with display information instructed by the CPU 101.

The operation receiver 106 includes pushbutton switches. The operation receiver 106 detects operations on the pushbutton switches and outputs operation signals to the CPU 101. The operation receiver 106 includes a musical piece selection switch 161, a musical piece start switch 162, and a musical piece stop switch 163, as shown in FIG. 2. The musical piece selection switch 161 is for selecting a musical piece to be played from multiple pieces of musical piece data. The musical piece start switch 162 is for instructing the start of automatic performance (playback) of a musical piece. The musical piece stop switch 163 is for instructing stop of automatic performance of a musical piece.

Although the operation receiver 106 in this embodiment includes pushbutton switches, the operation receiver 106 may include a touchscreen attached to the display 105 and output operation signals of the touchscreen to the CPU 101.

The keyboard 107 includes keys (operation elements, performance operation elements) and a detector that detects a key pressed or released by the user. The keyboard 107 outputs performance information that indicates the pitch and velocity of the pressed/released key and timing (tick) of the key press/release to the CPU 101. A key press is an operation made on an operation element to instruct sound production. A key release is releasing the operation made on the operation element. In the claims of the present application, an operation made on an operation element refers to a key press, which is an operation made on an operation element to instruct sound production, and does not include a key release, which releases the operation made on the operation element.

The sound source 108 reads waveform data (audio data) stored beforehand in the ROM 102 or generates waveform data and outputs the data to the DAC 109 in accordance with instructions by the CPU 101. The DAC 109 performs digital-to-analog conversion on the waveform data output by the sound source 108 and outputs analog audio. The output unit 110 includes an amplifier and speaker. The output unit 110 amplifies the analog audio (e.g., instrument audio) input by the DAC 109 and outputs the amplified analog audio. The sound source 108, the DAC 109, and the output unit 110 constitute a sound producer 111.

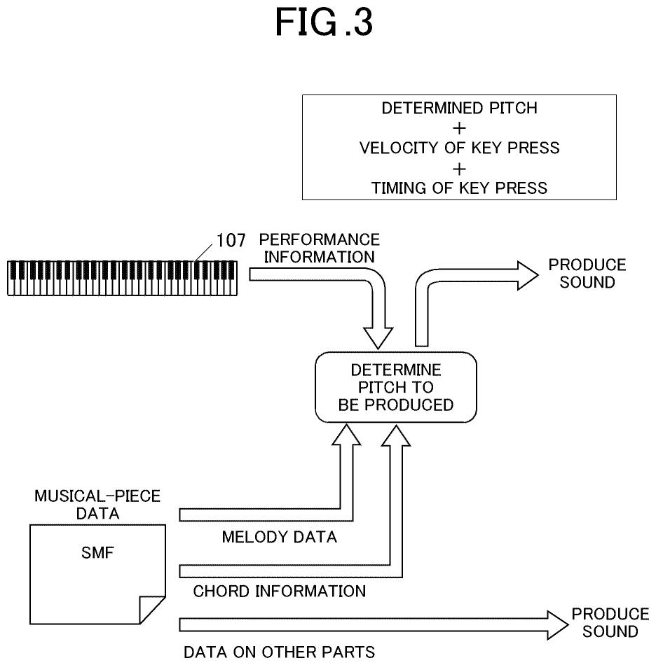

Next, operations of the electronic musical instrument 1 in this embodiment will be described. When the user selects a music piece with the operation receiver 106 and instructs the start of the music piece, the CPU 101 of the electronic musical instrument 1 sequentially processes the musical piece data according to the progress of the musical piece. Specifically, the CPU 101 progresses the musical piece as time passes and obtains melody data and chord information in the musical piece data, while instructing the sound source 108 to instantly produce sounds of other part data (automatic performance), as shown in FIG. 3. When the user operates (presses) a key on the keyboard 107, the CPU 101 determines the pitch of a musical note to be sounded in response to the user operation, based on the melody data and chord information received from the musical piece data and the pressed key position. The CPU 101 then instructs the sound source 108 to sound (produce a sound of) the musical note at the determined pitch. In response to receiving sound production instruction from the CPU 101, the sound source 108 sounds the musical note at the determined pitch with the velocity of the key press.

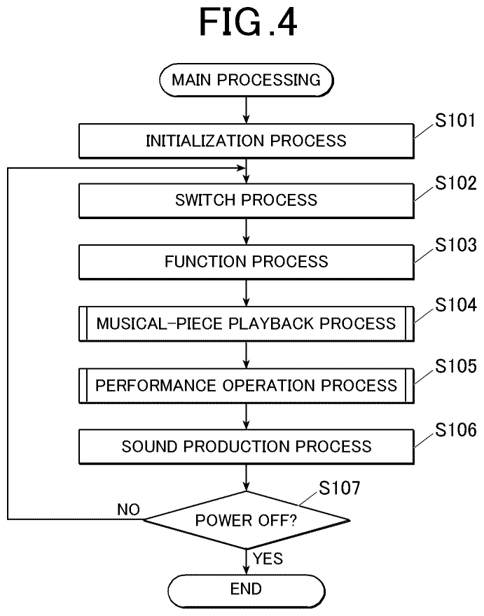

Hereinafter, processing by the electronic musical instrument 1 are described with reference to FIG. 4 to FIG. 9. The processing shown in FIG. 4 to FIG. 9 is executed by the CPU 101 in accordance with a program(s) stored in the ROM 102 or the storage 104.

When the electronic musical instrument 1 is turned on, the CPU 101 starts main processing shown in FIG. 4. In the main processing, the CPU 101 firstly executes an initialization process (step S101). In the initialization process, the CPU 101 initializes each component of the electronic musical instrument 1 and initializes buffers and variables used in the processes.

Next, the CPU 101 executes a switch process (step S102). In the switch process, the CPU 101 obtains the operational state of the switches of the operation receiver 106.

Next, the CPU 101 executes a function process (step S103). In the function process, the CPU 101 executes functions corresponding to the operational state of the switches obtained in the switch process.

For example, when the musical piece selection switch 161 is operated, the CPU 101 determines whether a musical piece is in progress (being played). When determining that a musical piece is not in progress, the CPU 101 executes a musical piece selection process. When determining that a musical piece is in progress, the CPU 101 stops the musical piece in progress and executes a musical piece selection process. In the musical piece selection process, the CPU 101 displays a list of names of selectable musical pieces on the display 105 and waits for a musical piece selection operation (musical piece designation operation) by the user. When receiving the musical piece selection operation, the CPU 101 reads out musical piece data of the selected musical piece from the storage 104 and loads the data onto the musical piece memory area of the RAM 103. A musical piece previously retained in the RAM 103 is overwritten and thereby deleted.

When the musical piece start switch 162 is operated, for example, the CPU 101 executes a musical piece start process. In the musical piece start process, the CPU 101 initializes variables and memory areas to be used in a musical piece playback process described later and starts progressing the musical piece, based on the musical piece data loaded in the musical piece memory area of the RAM 103. For example, the CPU 101 initializes the value of a variable “pre_tick”, which retains the tick at the last key press, to −60. The CPU 101 also clears and initializes data in the being-sounded melody area, the being-sounded chord area, and so forth in the RAM 103.

When the musical piece stop switch 163 is operated, for example, the CPU 101 executes a musical piece stop process to stop the musical piece in progress.

When other switches of the operation receiver 106 are operated, the CPU 101 executes other function processes according to the operation on the operation receiver 106.

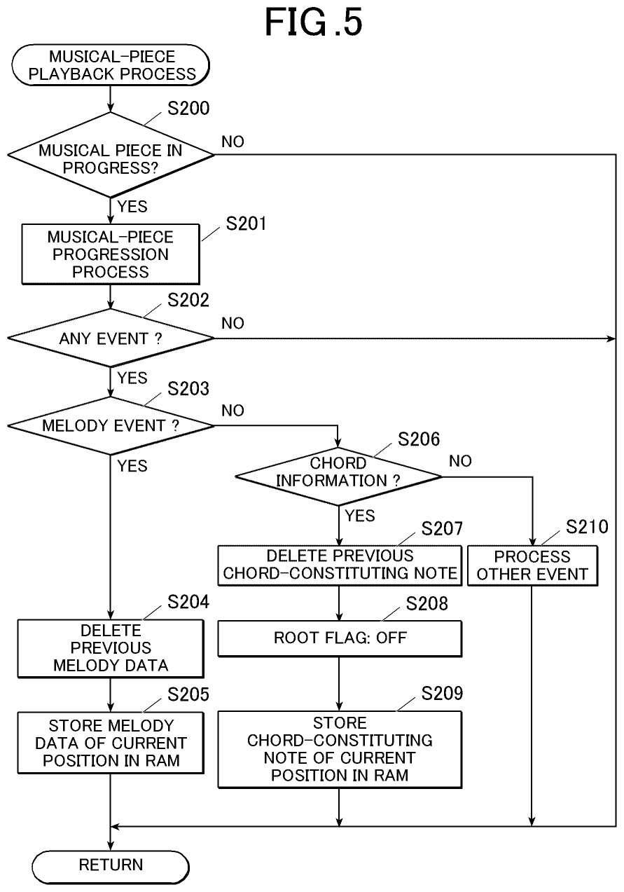

Next, the CPU 101 executes the musical piece playback process (step S104). Hereinafter, the musical piece playback process is described with reference to FIG. 5.

In the musical piece playback process, first, the CPU 101 determines whether a musical piece is currently in progress (step S200). When determining that a musical piece is not in progress (step S200: NO), the CPU 101 exits the musical piece playback process and proceeds to step S105 in FIG. 4. When determining that a musical piece is in progress (step S200: YES), the CPU 101 executes a musical piece progression process (step S201). In the musical piece progression process, the CPU 101 progresses the processing position in the musical piece data by the elapsed time from the last time the musical piece progression process was performed to the current time.

Next, the CPU 101 determines whether there is an event to be processed at the processing position in the musical piece data (step S202). When determining that there is no event to be processed at the processing position in the musical piece data (step S202: NO), the CPU 101 exits the musical piece playback process and proceeds to step S105 in FIG. 4.

When determining that there is an event to be processed at the processing position in the musical piece data (step S202: YES), the CPU 101 determines whether the event is a melody event (step S203). A melody event is a note-on event or a note-off event in the melody data of the musical piece. When determining that the event is a melody event (step S203: YES), the CPU 101 deletes the previous melody data retained in the melody memory area of the RAM 103 (step S204), stores the melody data of the current processing position in the melody memory area of the RAM 103 (step S205), and proceeds to step S105 in FIG. 4.

When determining that the event is not a melody event (step S203: NO), the CPU 101 determines whether the event is chord information (step S206). When determining that the event is chord information (step S206: YES), the CPU 101 deletes the previous chord information in the chord memory area of the RAM 103 and deletes the previous chord-constituting notes from the chord-constituting note memory area (step S207). The CPU 101 then turns off a root flag (Step S208). The root flag is turned on when the root note of a chord is being sounded. The CPU 101 stores the chord information of the current processing position in the chord memory area of the RAM 103 and stores the chord-constituting notes corresponding to the chord information in the chord-constituting note memory area of the RAM 103 (step S209). The CPU 101 then proceeds to step S105 in FIG. 4. The CPU 101 refers to the chord-constituting note table stored in the storage 104 to identify chord-constituting notes corresponding to the current chord information. The CPU 101 stores the identified chord-constituting notes in the chord-constituting note memory area of the RAM 103.

In Step S206, when determining that the event is not chord information (step S206: NO), the CPU 101 executes the other event process (step S210) and proceeds to step S105 in FIG. 4.

For example, if the event is a note-on event of a part other than the melody, the CPU 101 generates sound-production instruction information for causing the sound producer 111 to produce a sound corresponding to the note number and velocity of the note-on event, and outputs the information to the sound source 108. If the event is a note-off event of a part other than the melody, the CPU 101 generates mute instruction information for causing the sound producer 111 to stop producing the sound of the note number (mute the note number) of the note-off event, and outputs the information to the sound source 108. If the event is any other event, such as a program change or control change, the CPU 101 executes a process corresponding to the event.

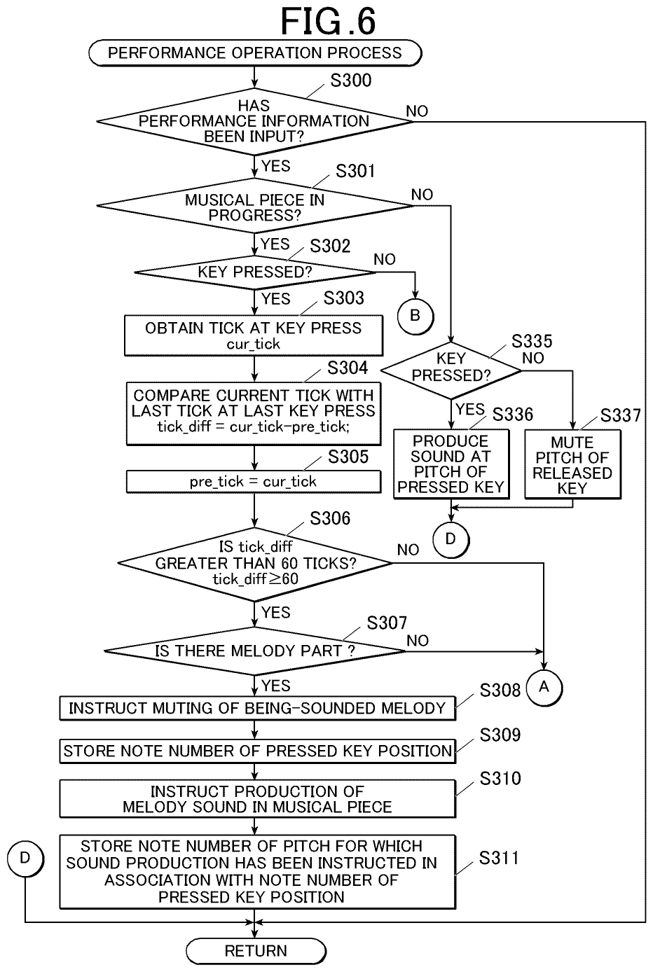

In step S105 of FIG. 4, the CPU 101 executes a performance operation process (step S105). The performance operation process is described below with reference to FIG. 6 to FIG. 9. In the performance operation process, first, the CPU 101 determines whether performance information has been input from the keyboard 107 (step S300). When determining that no performance information has been input from the keyboard 107 (step S300: NO), the CPU 101 proceeds to step S106 in FIG. 4.

When determining that performance information has been input from the keyboard 107 (step S300: YES), the CPU 101 determines whether a musical piece is in progress (step S301). When determining that a musical piece is in progress (step S301: YES), the CPU 101 determines whether the input performance information indicates that a key has been pressed (key press) (step S302). When determining that the input performance information indicates a key press (step S302: YES), the CPU 101 obtains the tick at the key press timing and stores the obtained tick in the variable cur_tick (step S303). The tick at the key press indicates a time period from the start of the musical piece to the key press timing.

Next, the CPU 101 calculates the difference (elapsed time) between the tick at the last key press retained in the variable pre_tick and the tick at the current key press retained in the variable cur_tick and stores the difference in the variable tick_diff (step S304). The CPU 101 then stores the value of the variable cur_tick in the variable pre_tick (step S305). In this embodiment, the initial value of the variable pre_tick is −60. By setting the initial value of the variable pre_tick to −60, the value of the variable tick_diff is greater than or equal to 60 even when a first key press is within 60 ticks from the start of a musical piece. Thus, if melody data is present at the first key press timing, the melody note will be sounded.

Next, the CPU 101 determines whether the value of the variable tick_diff is greater than or equal to a threshold (60 ticks in this embodiment) (step S306). That is, the CPU 101 determines whether the current key press has been made after 60 ticks or longer have elapsed from the last key press. The threshold of 60 ticks is determined based on a thirty-second note, for example. The threshold may be set to a different value.

When determining that the value of the variable tick_diff is 60 or greater (step S306: YES), the CPU 101 determines whether there is a melody part at the current position in the musical piece (step S307). Whether there is a melody part at the current position in the musical piece can be determined, based on whether the melody data in the melody memory area of the RAM 103 has pitch information (does not have rest information), for example.

When determining that there is a melody part at the current position in the musical piece (step S307: YES), the CPU 101 executes a process of producing a melody sound (sounding a melody note) in response to the current key press. First, the CPU 101 determines whether the being-sounded melody area of the RAM 103 retains a pitch (note number) of the being-sounded melody. If YES, the CPU 101 generates mute instruction information for muting the being-sounded melody and outputs the information to the sound source 108. Further, the CPU 101 deletes the note number (pitch) for which the mute instruction has been made and the note number of the corresponding pressed key position from the being-sounded melody area of the RAM 103 (step S308).

Next, the CPU 101 stores the note number of the pressed key in the being-sounded melody area of the RAM 103, as the note number of the pressed key position (step S309). The CPU 101 then obtains the pitch (note number) of the current melody data retained in the melody memory area of the RAM 103; generates sound-production instruction information for causing the sound producer 111 to produce a sound at the obtained note number with the velocity of the key press obtained from the performance information; and outputs the information to the sound source 108 (step S310). The CPU 101 stores, in the being-sounded melody area of the RAM 103, the note number of the pitch for which the sound production instruction has been made in association with the note number of the pressed key position stored in step S309 (step S311). The CPU 101 then proceeds to step S106 in FIG. 4.

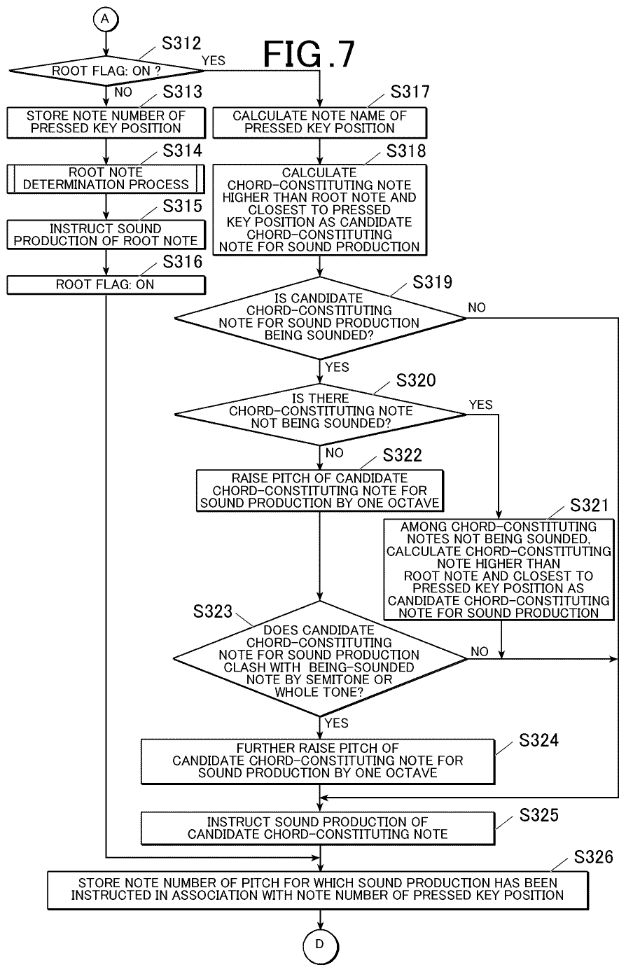

On the other hand, when determining in Step S306 that the value of the variable tick_diff is less than 60 (step S306: NO) or determining in Step S307 that there is no melody part at the current position of the musical piece (step S307: NO), the CPU 101 proceeds to step S312 in FIG. 7 and executes a process of sounding a chord-constituting note in response to the current key press.

In step S312 of FIG. 7, the CPU 101 determines whether the root flag is on (step S312). When determining that the root flag is not on (step S312: NO), the CPU 101 stores the note number of the pressed key in the being-sounded chord area of the RAM 103 (step S313). Next, the CPU 101 executes a root note determination process (step S314).

Hereinafter, note-name numbers and octave ranges used in the subsequent processes are described. Pitches are expressed by note numbers defined by the MIDI standard. For example, the pitch of C4, which is the middle key of a normal 88-key piano, is 60. The pitch of C8, which is the rightmost key with the highest pitch, is 108. The pitch of A0, which is the leftmost key with the lowest pitch, is 21. The remainder of a pitch divided by 12 corresponds to a note name, which indicates a pitch within one octave. In this embodiment, the note name C is set to 0 (zero), and the note names C to B are assigned with note numbers 0 to 11 in order. That is, C4 and C8 have the same note name C and are indicated by the number 0. Further, the quotient of a pitch divided by 12 corresponds to an octave range that includes the said pitch. The pitch of A0, which is the lowest on an 88-key piano, is 21. Since the quotient of 21 divided by 12 is 1, the octave range of A 0 is 1. For another example, the pitch of C4 is 60. Since the quotient of 60 divided by 12 is 5, the octave range of C4 is 5. A pitch (note number) can be calculated from a note name and an octave range by Expression 1: Pitch=12×octave range+note-name number. Each octave range includes notes having the note-name numbers of 0 to 11.

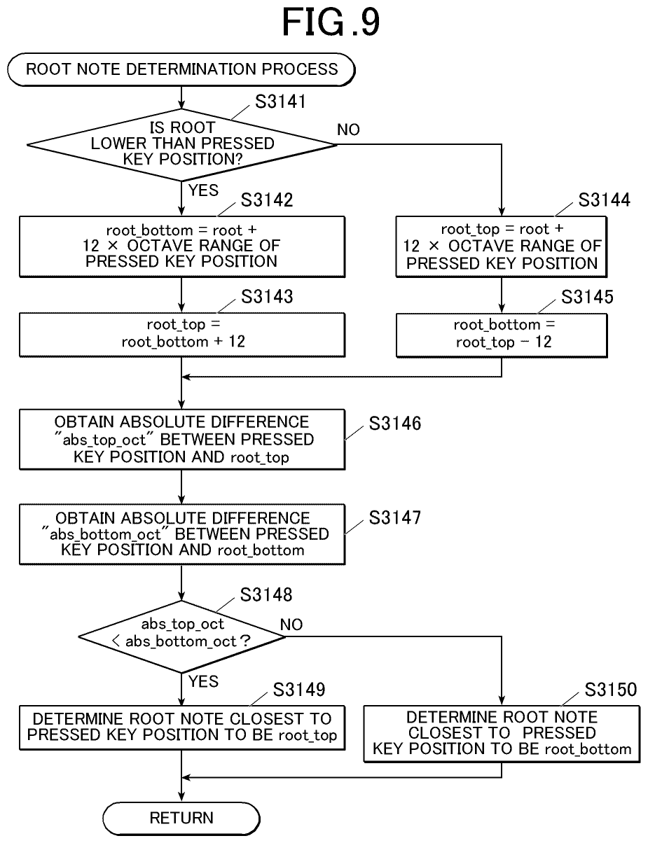

Hereinafter, the root note determination process is described with reference to FIG. 9. First, in the octave range that includes the pressed key, the CPU 101 determines whether the root note of the current chord is lower (has a lower pitch) than the pressed key position (step S3141). Specifically, in the octave range that includes the pressed key, the CPU 101 determines whether the root note among the current chord-constituting notes (the lowest note among the chord-constituting notes) in the chord-constituting note memory area of the RAM 103 is lower than the pressed key position.

When determining that, in the octave range that includes the pressed key, the root note of the current chord is lower than the pressed key position (step S3141: YES), the CPU 101 calculates root_bottom that is the note number of the root note less than the note number of the pressed key position and closest to the pressed key position (step S3142). Specifically, root_bottom is calculated with the following Expression 2: root_bottom=note−name number of the root note (root)+12×octave range of the pressed key position.

Next, the CPU 101 calculates root_top that is the note number of the root note greater than the note number of the pressed key position and closest to the pressed key position, by adding 12 to root_bottom (step S3143). The CPU 101 then proceeds to step S3146.

When determining that, in the octave range including the pressed key, the root note of the current chord is not lower than the pressed key position (step S3141: NO), the CPU 101 calculates root_top, which is the note number of the root note greater than the note number of the pressed key position and closest to the pressed key position (step S3144). Specifically, root_top is calculated with the following Expression 3: root_top=note−name number of the root note (root)+12×octave range of the pressed key position.

Next, the CPU 101 calculates root_bottom, which is the note number of the root note less than the note number of the pressed key position and closest to the pressed key position, by subtracting 12 from root_top (step S3145). The CPU 101 then proceeds to step S3146.

In step S3146, the CPU 101 calculates abs_top_oct that is the absolute value of the difference between the note number of the pressed key position and root_top (step S3146). The CPU 101 calculates abs_bottom_oct that is the absolute value of the difference between the note number of the pressed key position and root_bottom (step S3147).

The CPU 101 then determines whether “abs_top_oct<abs_bottom_oct” holds (step S3148). When determining that “abs_top_oct<abs_bottom_oct” holds (step S3148: YES), the CPU 101 determines that the root note closest to the pressed key position is root_top and stores root_top in a variable NRNN (nearest root note number) (step S3149). The CPU 101 then proceeds to Step S315 in FIG. 7. When determining that “abs_top_oct<abs_bottom_oct” does not hold (step S3148: NO), the CPU 101 determines that the root note closest to the pressed key position is root_bottom and stores root_bottom in the variable NRNN (step S3150). The CPU 101 then proceeds to Step S315 in FIG. 7.

In step S315 of FIG. 7, the CPU 101 obtains the note number of the root note closest to the pressed key position (the value of NRNN) determined in the root note determination process, generates sound-production instruction information for causing the sound producer 111 to produce the sound at the obtained note number with the velocity of the key press, and outputs the information to the sound source 108 (step S315). The CPU 101 turns on the root flag (step S316) and proceeds to step S326.

On the other hand, when determining in step S312 that the root flag is on (step S312: YES), namely determining that the root note is being sounded, the CPU 101 calculates the note name (the note-name number) of the pressed key position (step S317). As described above, the note name (note-name number) of the pressed key position is the remainder when dividing the note number of the pressed key position by 12.

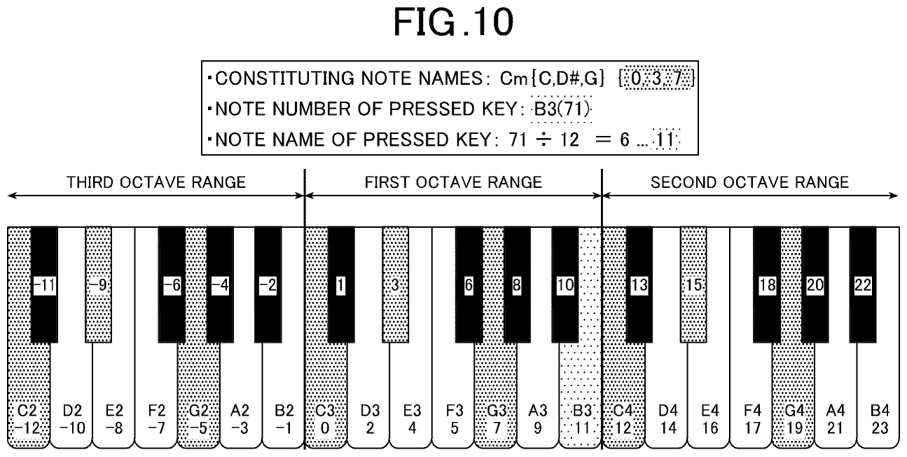

Next, the CPU 101 derives (calculates) the chord-constituting note that is higher than the root note (the value of the variable NRNN) and closest to the pressed key position, as a candidate chord-constituting note for sound production (step S318). The chord-constituting note higher than the root note and closest to the pressed key position may not be in the octave range including the pressed key position (a first octave range) but may be in a second octave range that is one octave above the first octave range or in a third octave range that is one octave below the first octave range. For example, as shown in FIG. 10, assume that the current chord is Cm, which consists of chord-constituting notes of C, D♯, and G. If B3 in the first octave range is pressed, the chord-constituting note that is higher than the root note and closest to the pressed key position is D♯ in the second octave range. In deriving the candidate chord-constituting note for sound production, the CPU 101 considers not only the chord-constituting notes in the first octave range but also the chord-constituting notes in the second and third octave ranges. Thus, the CPU 101 derives the chord-constituting note higher than the root note and closest to the pressed key position. For example, as shown in FIG. 10, the notes in the first octave range are assigned with note-name numbers of 0 to 11; the notes in the second octave range are assigned with note-name numbers of 12 to 23 by adding 12 to the respective note-name numbers of the first octave range; and the notes in the third octave range are assigned with note-name numbers of −1 to −12 by subtracting 12 from the respective note-name numbers of the first octave range. Then, a chord-constituting note that is higher than the root note (the value of the variable NRNN) and that has the smallest absolute difference in note-name numbers from the pressed key position is determined to be the candidate chord-constituting note for sound production. If there are multiple chord-constituting notes closest to the pressed key position (e.g., both sides of the pressed key position are chord-constituting notes), the lower chord-constituting note is prioritized in this embodiment. However, the higher chord-constituting note may be prioritized.

Next, the CPU 101 determines whether the candidate chord-constituting note for sound production is being sounded (step S319). For example, the CPU 101 refers to the being-sounded chord area of the RAM 103 to determine whether the candidate chord-constituting note for sound production is being sounded. When determining that the candidate chord-constituting note for sound production is not being sounded (step S319: NO), the CPU 101 proceeds to step S325.

When determining that the candidate chord-constituting note for sound production is being sounded (step S319: YES), the CPU 101 determines whether there is any chord-constituting note not being sounded (step S320). The chord-constituting note herein refers to a chord-constituting note in the same octave range as the root note of the variable NRNN. When determining that there is a chord-constituting note(s) not being sounded (step S320: YES), the CPU 101 derives, from the not-being-sounded chord-constituting note(s), a chord-constituting note higher than the root note and closest to the pressed key position as the candidate chord-constituting note for sound production (step S321). The CPU 101 then proceeds to step S325.

When determining that there is no chord-constituting note not being sounded (step S320: NO), the CPU 101 raises the pitch of the candidate chord-constituting note for sound production by one octave (step S322) and determines whether the candidate chord-constituting note for sound production with the raised pitch clashes with a being-sounded note(s) by a semitone or whole tone (step S323). Herein, if the pitch of the candidate chord-constituting note for sound production is the same as or next to the pitch of the being-sounded note, the CPU 101 determines that the candidate chord-constituting note for sound production clashes with the being-sounded note by a semitone or whole tone.

When determining that the candidate chord-constituting note for sound production does not clash with the being-sounded note by a semitone or whole tone (step S323: NO), the CPU 101 proceeds to step S325. When determining that the candidate chord-constituting note for sound production clashes with the being-sounded note by a semitone or whole tone (step S323: YES), the CPU 101 further raises the pitch of the candidate chord-constituting note for sound production by one octave (step S324). The CPU 101 then proceeds to step S325.

In step S325, the CPU 101 generates sound-production instruction information for causing the sound producer 111 to produce a sound at the note number of the candidate chord-constituting note for sound production with the velocity of the key press, and outputs the information to the sound source 108 (step S325). The CPU 101 stores, in the being-sounded chord area of the RAM 103, the pitch of the candidate chord-constituting note for which sound-production instruction has been made in association with the note number of the pressed key position (step S326). The CPU 101 then proceeds to step S106 in FIG. 4.

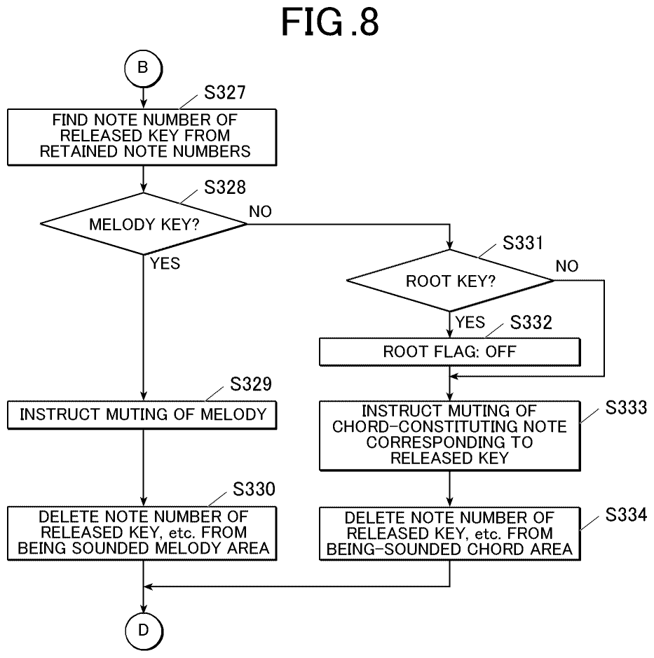

On the other hand, in Step S302, when determining that a key is not pressed (i.e., a key is released) (step S302: NO), the CPU 101 proceeds to step S327 in FIG. 8. The CPU 101 searches for the note number of the released key from the note numbers of being-pressed keys stored in the being-sounded melody area and the being-sounded chord area of the RAM 103 (step S327).

Based on the search result, the CPU 101 determines whether the released key corresponds to the being-sounded melody note (melody key) (step S328). When determining that the released key corresponds to the being-sounded melody note (step S328: YES), the CPU 101 generates mute instruction information for muting the melody note being sounded for that key and outputs the information to the sound source 108 (step S329). The CPU 101 deletes the note number of the released key and the note number of the pitch sounded in response to the press of the key from the being-sounded melody area of the RAM 103 (step S330). The CPU 101 then proceeds to step S106 in FIG. 4.

When determining that the released key does not correspond to the being-sounded melody note (step S328: NO), the CPU 101 determines whether the released key corresponds to the being-sounded root note (root key) (step S331). When determining that the released key corresponds to the being-sounded root note (step S331: YES), the CPU 101 turns off the root flag (step S332) and proceeds to step S333. The root flag, which indicates that the root note is being sounded, is turned off here because the key corresponding to the being-produced root note has been released and the root note will be muted in the next step. When determining that the released key does not correspond to the being-sounded root note (step S331: NO), the CPU 101 proceeds to step S333.

In step S333, the CPU 101 generates mute instruction information for muting the chord-constituting note being sounded for the released key and outputs the information to the sound source 108 (step S333). The CPU 101 then deletes the note number of the released key and the note number of the pitch sounded in response to the key press of the released key from the being-sounded chord area of the RAM 103 (step S334). The CPU 101 then proceeds to step S106 in FIG. 4.

On the other hand, in Step S301, when determining that a musical piece is not in progress (step S301: NO), the CPU 101 determines whether the input performance information indicates that a key has been pressed (step S335). When determining that the input performance information indicates that a key has been pressed (step S335: YES), the CPU 101 generates sound-production instruction information at the pitch and with the velocity of the key press, and outputs the information to the sound source 108 (step S336). The CPU 101 then proceeds to step S106 in FIG. 4. When determining that the input performance information does not indicate that a key has been pressed but indicates that a key has been released (step S335: NO), the CPU 101 generates mute instruction information for muting the pitch of the released key and outputs the information to the sound source 108 (step S337). The CPU 101 then proceeds to step S106 in FIG. 4.

In step S106 of FIG. 4, the CPU 101 executes a sound production process (step S106). In the sound production process, the CPU 101 causes the sound producer 111 to produce a sound of a musical note, mute a musical note, or change the sound of a musical note, based on the sound-production instruction information, mute instruction information, or other information instructing tone change, volume change, or the like that have been output to the sound source 108 in the musical piece playback process or the performance operation process.

Next, the CPU 101 determines whether the power switch of the operation receiver 106 has been pressed, namely whether power off has been instructed (step S107). When determining that the power switch of the operation receiver 106 has not been pressed (step S107: NO), the CPU 101 returns to step S102 and repeats steps S102 to S107. When determining that the power switch of the operation receiver 106 has been pressed (step S107: YES), the CPU 101 ends the main processing.

FIG. 11 shows a case where a melody is sounded and a case where a chord (chord-constituting note) is sounded according to the above-described processing, when the user plays the electronic musical instrument 1 while a musical piece is played (in progress) by the electronic musical instrument 1. As shown in FIG. 11, in response to a key press at a timing t1 (the first key press in the musical piece), a melody note M1 corresponding to the timing t1 in the musical piece is sounded. In response to a key press at a timing t2 after a lapse of 60 ticks or longer from the timing t1, a melody note M2 corresponding to the timing t2 in the musical piece is sounded. In response to a key press at a timing t3 with an interval shorter than 60 ticks from the timing t2, a chord-constituting note C1 of the chord corresponding to the timing t3 in the musical piece is sounded. In response to a key press at a timing t4 with an interval shorter than 60 ticks from the timing t3, a chord-constituting note C2 of the chord corresponding to the timing t4 in the musical piece is sounded. In response to a key press at a timing t5 after a lapse of 60 ticks or longer from the timing t4, a melody note M3 corresponding to the timing t5 in the musical piece is sounded, even though the melody note M2 is still being sounded. At this time, the being-sounded melody note M2 is muted. That is, when the user presses a key after a lapse of 60 ticks or longer from the last key press, the melody note having been sounded is muted and the next melody note is sounded, even if the user does not release the key corresponding to the melody note having been sounded.

As described above, the electronic musical instrument 1 determines which to sound, a melody or a chord, based on the elapsed time from the last key press. Therefore, the electronic musical instrument 1 allows the user to easily play both the melody and chord, without dividing the keyboard 107 into regions. Further, the electronic musical instrument 1 sounds a melody note when the user presses any of the keys after a predetermined time (60 ticks) has elapsed. Thus, the melody notes can be switched even if the key corresponding to the being-sounded melody note is not released.

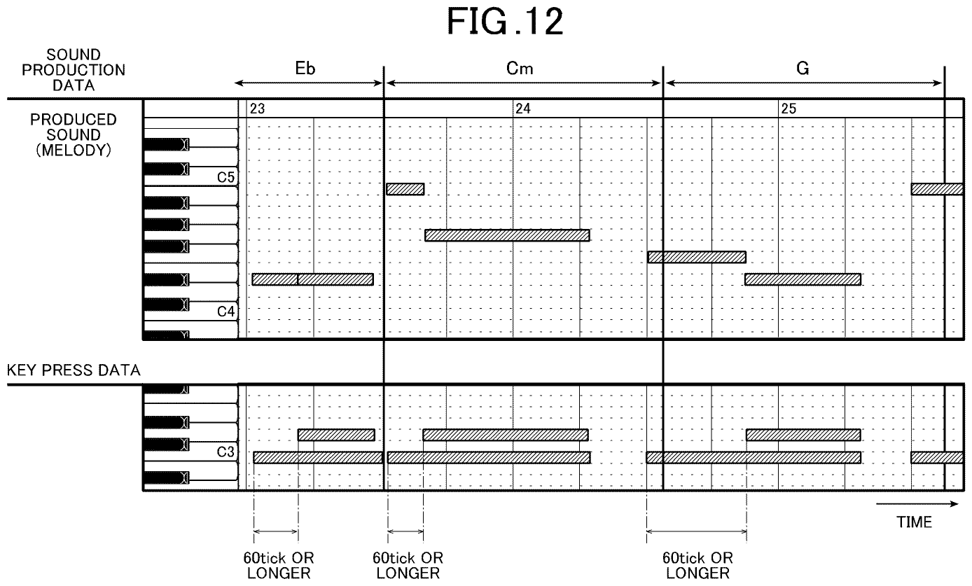

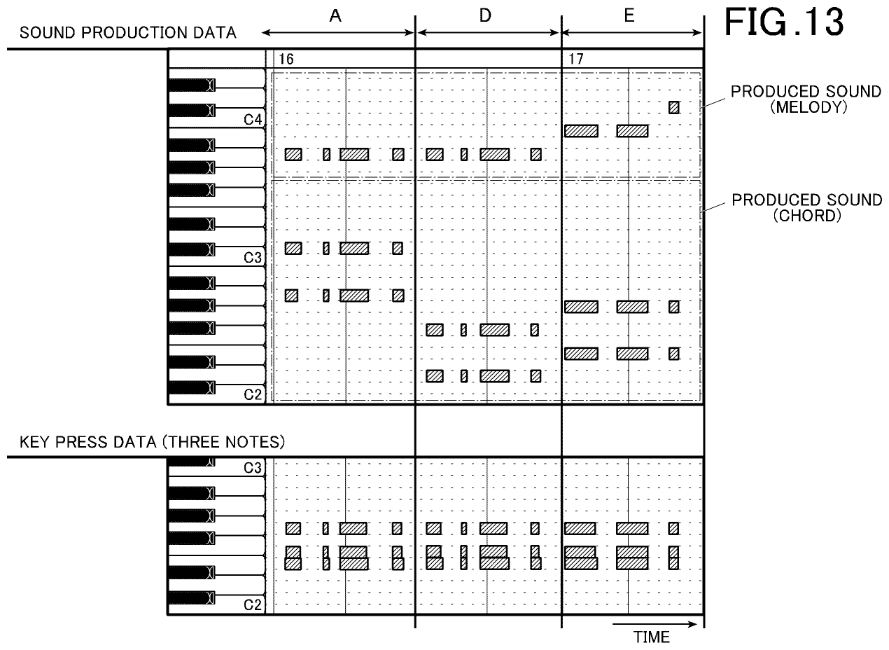

FIG. 12 and FIG. 13 show key press data and sound production data corresponding to the key press data while a musical piece is in progress in the above electronic musical instrument 1. In FIG. 12 and FIG. 13, the lower is the key press data, and the upper is the sound production data. In FIG. 12 and FIG. 13, the vertical axis represents pitches; the horizontal axis represents time; and the key press period and sound production period are indicated by shaded rectangles. A keyboard is illustrated on the left side so that pitches are easily recognized. Chord information at each timing of the horizontal axis is shown at the top. FIG. 12 shows an example of how notes are sounded when a first key is kept pressed and a second key is pressed after a lapse of 60 ticks or longer from the first key press. FIG. 13 shows how notes are sounded when three keys are pressed almost simultaneously (within an interval shorter than 60 ticks from the last key press), namely a chord is played, after a lapse of 60 ticks or longer from the key press immediately before the press of the three keys.

FIG. 12 shows a case where the user presses a second key after a lapse of 60 ticks or longer from a first key press while the user keeps pressing the first key. In this case, the melody sound is updated to the melody at the timing of the second key press, and the melody note having been sounded is muted. Thus, in this embodiment, by pressing a key after a lapse of 60 ticks or longer from the last key press, the user can play the melody according to the musical piece in progress, without releasing the last key press.

FIG. 13 shows a case where the user presses multiple keys at an interval shorter than 60 ticks from each other (i.e., plays a chord) after a lapse of 60 ticks or longer from the last key press. In this case, in response to the first key press, a melody note is sounded. In response to the second key press, the root note of the current chord (the root note closest to the pressed key position) is sounded. In response to the third key press, a chord-constituting note higher than the root note and closest to the pressed key position is sounded. Thereafter, if keys of a chord (e.g., the same chord as before) are pressed after a lapse of 60 ticks or longer, the electronic musical instrument 1 switches sounds to the sounds of the melody note and chord-constituting notes including the root note as the lowest at the timing of the key press, according to the number of pressed keys. Thus, by a simple operation of repetitively pressing the same chord keys, for example, the user can play the melody and chord-constituting notes according to the musical piece in progress, as shown in FIG. 13. Further, the root note is always sounded at the lowest pitch in the chord, so that the user can stably play the musical piece.

As explained above, in response to a current operation of operating (pressing) an operation element among the operation elements of the keyboard 107 by the user while a specified musical piece is in progress, the CPU 101 of the electronic musical instrument 1 determines whether the current operation is performed after a lapse of a predetermined time from an operation immediately before the current operation. In response to determining that the current operation is performed before the lapse of the predetermined time, the CPU 101 causes the sound producer 111 to sound a chord-constituting note at a timing of the current operation in the musical piece. In response to determining that the current operation is performed after the lapse of the predetermined time, the CPU 101 causes the sound producer 111 to sound a current melody note at the timing of the current operation in the musical piece. Therefore, the electronic musical instrument 1 can produce good sounds no matter how the user plays the instrument 1 to a musical piece including a melody and chords. For example, no matter which region of the keyboard 107 is operated, the electronic musical instrument 1 can sound a melody or a chord-constituting note according to the operation timing (key press timing). If multiple operation elements are operated at almost the same time, the melody and chord can be sounded at the same time. Further, even if a key that sounded a melody note is not released, a new melody note can be sounded according to the progress of the musical piece in response to a new key press after a lapse of a predetermined time.

Further, for example, in a case where a previous melody note is being sounded in causing the sound producer 111 to sound the current melody note at the timing of the current operation in the musical piece, the CPU 101 causes the sound producer 111 to mute the previous melody note being sounded. Thus, duplication of melody sounds can be prevented.

Further, for example, in response to determining that the current operation is performed before the lapse of the predetermined time, the CPU 101 determines whether a root note is being sounded among the chord-constituting notes constituting the current chord in the musical piece. In response to determining that the root note is not being sounded, the CPU 101 causes the sound producer 111 to sound the root note. Therefore, the root note among the chord-constituting notes in a musical piece can be prioritized in producing sounds.

Further, in response to determining that the current operation is performed before the lapse of the predetermined time and that the root note among the chord-constituting notes is being sounded, the CPU 101 causes the sound producer 111 to sound a chord-constituting note that is not being sounded among the chord-constituting notes having higher pitches than the root note. Since the root note is sounded at the lowest pitch in the chord, the performance can be stable.

Further, in a case where a pitch of the chord-constituting note to be sounded by the sound producer 111 is identical to or adjacent to a pitch of a note being sounded, the CPU 101 raises the pitch of the chord-constituting note to be sounded by one octave and causes the sound producer 111 to sound the chord-constituting note having the raised pitch. Thus, clashing of adjacent pitches is avoided, and good musical sounds can be produced.

Further, the CPU 101 causes the sound producer 111 to produce sounds such that the number of notes of the user performance part sounded by the sound producer 111 is equal to the number of operation elements operated by the user. Therefore, the electronic musical instrument 1 can sound the number of notes corresponding to the user performance.

The embodiment described above is a preferable example of the electronic musical instrument, the sound production control method, and a storage medium storing a program according to the present disclosure. The embodiment is not intended to limit the present disclosure.

For example, in the above embodiment, the CPU 101 of the electronic musical instrument 1 performs the main processing in cooperation with the program stored in the ROM 102 and thereby performs the functions of the present disclosure. However, a computer different from the electronic musical instrument 1 and connected to the electronic musical instrument 1 may perform the functions of the present disclosure.

Further, in the above embodiment, the electronic musical instrument 1 is a keyboard instrument as an example. The electronic musical instrument 1 may be a different electronic musical instrument, such as a wind synthesizer, an electric guitar, or a MIDI violin.

Further, in Step S318, the CPU 101 derives the candidate chord-constituting note for sound production that is higher than the root note (NRNN) and closest to the pressed key position; and in Step S321, the CPU 101 derives the candidate chord-constituting note for sound production that is higher than the root note and closest to the pressed key position among not-sounded chord-constituting notes. However, the candidate chord-constituting note for sound production is not limited to these. For example, the candidate chord-constituting note for sound production derived in step S318 may be higher than the root note (NRNN) and closest to the root note; and the candidate chord-constituting note for sound production derived in step S321 may be higher than the root note and closest to the root note among the not-sounded chord-constituting notes.

In the above embodiment, a hard disk and/or a semiconductor memory, such as a ROM, are used as an example of a computer-readable medium storing the program of the present disclosure. However, the computer-readable medium is not limited thereto. The computer-readable medium can be a portable storage medium, such as a CD-ROM. Further, a carrier wave can be used as a medium to provide data of the program of the present disclosure via a communication line.

The detailed configuration and detailed operations of the electronic musical instrument 1 can be appropriately modified without departing from the scope of the present disclosure.

Although the embodiment of the present disclosure has been described above, the technical scope of the present disclosure is not limited to the embodiment described above but is defined based on the claims. Further, the technical scope of the present disclosure includes equivalents that involve changes unrelated to the essence of the invention described in the claims.

1. An electronic musical instrument comprising:
multiple operation elements;
a sound producer; and
a processor that:
starts progressing a musical piece, based on musical piece data,
in response to a current operation of an operation element among the operation elements being performed by a user while the musical piece is in progress, determines whether the current operation is performed after a lapse of a predetermined time from an operation immediately before the current operation,
in response to determining that the current operation is performed before the lapse of the predetermined time, causes the sound producer to sound a chord-constituting note among chord-constituting notes at a timing of the current operation in the musical piece, and
in response to determining that the current operation is performed after the lapse of the predetermined time, causes the sound producer to sound a current melody note at the timing of the current operation in the musical piece.

2. The electronic musical instrument according to claim 1, wherein in a case where a previous melody note is being sounded in causing the sound producer to sound the current melody note, the processor causes the sound producer to mute the previous melody note.

3. The electronic musical instrument according to claim 1, wherein:
in response to determining that the current operation is performed before the lapse of the predetermined time, the processor determines whether a root note among the chord-constituting notes is being sounded, and
in response to determining that the root note is not being sounded, the processor causes the sound producer to sound the root note.

4. The electronic musical instrument according to claim 3, wherein in response to determining that the root note is being sounded, the processor causes the sound producer to sound a chord-constituting note that is not being sounded among the chord-constituting notes having higher pitches than the root note.

5. The electronic musical instrument according to claim 4, wherein in a case where a pitch of the chord-constituting note to be sounded by the sound producer is identical to or adjacent to a pitch of a note being sounded, the processor raises the pitch of the chord-constituting note to be sounded by one octave and causes the sound producer to sound the chord-constituting note having the raised pitch.

6. The electronic musical instrument according to claim 1, wherein the processor causes the sound producer to produce sounds such that a number of notes of a user performance part sounded by the sound producer is equal to a number of operation elements operated by the user.

7. A sound production method to be performed by a computer, wherein the computer:
starts progressing a musical piece, based on musical piece data,
in response to a current operation of an operation element among the operation elements being performed by a user while the musical piece is in progress, determines whether the current operation is performed after a lapse of a predetermined time from an operation immediately before the current operation,
in response to determining that the current operation is performed before the lapse of the predetermined time, causes the sound producer to sound a chord-constituting note among chord-constituting notes at a timing of the current operation in the musical piece, and
in response to determining that the current operation is performed after the lapse of the predetermined time, causes the sound producer to sound a current melody note at the timing of the current operation in the musical piece.

8. The sound production method according to claim 7, wherein in a case where a previous melody note is being sounded in causing the sound producer to sound the current melody note, the computer causes the sound producer to mute the previous melody note.

9. The sound production method according to claim 7, wherein:
in response to determining that the current operation is performed before the lapse of the predetermined time, the computer determines whether a root note among the chord-constituting notes is being sounded, and
in response to determining that the root note is not being sounded, the computer causes the sound producer to sound the root note.

10. The sound production method according to claim 9, wherein in response to determining that the root note is being sounded, the computer causes the sound producer to sound a chord-constituting note that is not being sounded among the chord-constituting notes having higher pitches than the root note.

11. The sound production method according to claim 10, wherein in a case where a pitch of the chord-constituting note to be sounded by the sound producer is identical to or adjacent to a pitch of a note being sounded, the computer raises the pitch of the chord-constituting note to be sounded by one octave and causes the sound producer to sound the chord-constituting note having the raised pitch.

12. The sound production method according to claim 7, wherein the computer causes the sound producer to produce sounds such that a number of notes of a user performance part sounded by the sound producer is equal to a number of operation elements operated by the user.

13. A non-transitory computer-readable storage medium storing a program that causes a computer to perform processing, wherein in the processing, the computer:
starts progressing a musical piece, based on musical piece data,
in response to a current operation of an operation element among the operation elements being performed by a user while the musical piece is in progress, determines whether the current operation is performed after a lapse of a predetermined time from an operation immediately before the current operation,
in response to determining that the current operation is performed before the lapse of the predetermined time, causes the sound producer to sound a chord-constituting note among chord-constituting notes at a timing of the current operation in the musical piece, and
in response to determining that the current operation is performed after the lapse of the predetermined time, causes the sound producer to sound a current melody note at the timing of the current operation in the musical piece.
